(19) United States
(12) Patent Application Publication
(10) Pub. No.: US 2006/0125245 A1
(43) Pub. Date: Jun. 15, 2006

(54) Multifunctional lever

(76) Inventors: Ludger Graute, Essen (DE); Dirk Hanisch, Koln (DE)

Correspondence Address: MATTHIAS SCHOLL, 14781 MEMORIAL DRIVE, SUITE 1319, HOUSTON, TX, 77079, US

(21) Appl. No.: 10/555,305

(22) PCT Filed: Apr. 30, 2004
(86) PCT No.: PCT/DE04/00917

§ 371 Date: Nov. 2, 2005

(30) Foreign Application Priority Data
May 8, 2003 (DE) 103 20 445.8

(51) Int. Cl. E05C 3/06

(52) U.S. Cl. 292/216

(57) ABSTRACT

The invention refers to a multi-functional lever consisting of a basic lever for a first actuating function and with at least one lever element branching off from the basic lever for a second actuating function, in which the lever element forms a subassembly with the basic lever or is connected to the basic lever.

### CROSS-REFERENCE TO RELATED APPLICATIONS

This is a National Stage Application of International Patent Application No. PCT/DE 2004/000917, with an international filing date of Apr. 30, 2004, which is based on German Patent Application No. 103 20 445.8, filed May 8, 2003. The contents of both of these specifications are incorporated herein by reference.

### BACKGROUND OF THE INVENTION

1. Field of the Invention

The invention refers to a multi-functional lever for the lever mechanism of, in particular, a vehicle door latch.

2. Description of Related Art

In known lever mechanisms, the individual levers regularly carry out a certain actuating function and are therefore produced and used for this actuating function. For vehicle door latches with catch, pawl and release lever for the actuation of the pawl, on one hand, a mechanical operation of the release lever and, on the other hand, a motor-driven operation is known. For mechanical operation, a Bowden cable, rod, etc. may, for instance, be used, whilst an electrical motor is used for motor-driven operation. Between the electrical motor and the release lever a set of gears, connecting means, such as other levers, a Bowden cable, a rod etc., may be arranged. In any case, the release lever is designed differently for mechanical than for motor-driven operation so that two different release levers are available and have to be produced and used, as applicable. This depends on whether the vehicle door latch is designed for a mechanical or a motor-driven operation.

From a technical production and installation point of view, the known procedure described above is costly for any lever mechanism, irrespective in which technical field such a lever mechanism is used.—The invention aims to remedy this situation.

### BRIEF DESCRIPTION OF THE DRAWINGS

Below, the invention is explained in more detail with reference to a drawing showing only one embodiment, in which:

FIG. 1 shows a vehicle door latch according to the invention with a back plate and the main components relevant for the invention in a mechanically operated version

FIG. 2 shows the object of FIG. 1 with the multi-functional lever in a motor-driven embodiment in another functional position and

FIG. 3 shows the object of FIG. 1 with a release lever and with a driving arm connected to the release lever on the same axis, in a motor-driven embodiment.

### BRIEF SUMMARY OF THE INVENTION

The invention described herein provides a multi-functional lever for a lever mechanism, in particular, for a lever mechanism of a vehicle door latch, characterized by a basic lever (1) for a first actuating function and one or, where applicable, more lever elements (2, 3) branching off from the basic lever for a second and, where applicable, more actuating functions, in which the lever elements (2, 3) form a sub-assembly with the basic lever (1) or are connected to basic lever (1).

In certain embodiments of the invention described herein, the lever elements (2, 3) are riveted, glued or welded to the basic lever (1).

In certain embodiments of the invention described herein, the lever elements are clipped to the basic lever.

In certain embodiments of the invention described herein, the lever elements (2, 3) are connected to the basic lever (1) on the same axis.

In certain embodiments of the invention described herein, the lever elements (2, 3) are rigidly connected to the basic lever (1).

The invention described herein provides further a multi-functional lever for a vehicle door latch with at least a catch, a pawl for the catch and a release lever for actuation of the pawl, characterized in that the release lever (1), as a basic lever, contains at least a driving arm (2) designed as a branching-off lever element, cooperating with a motor-driven driving wheel (5).

In certain embodiments of the invention described herein, an electrical motor (6) with a pinion or worm gear (7) acts upon the driving wheel (5) containing a gear rim or gear rim section.

In certain embodiments of the invention described herein, the driving wheel (5) contains a radial cam (8) for the driving arm (2).

In certain embodiments of the invention described herein, the release lever (1), as a basic lever, contains an operating lever (3) as a branching-off lever element.

In certain embodiments of the invention described herein, the driving arm (2) and/or the operating lever (3) form a sub-assembly together with the release lever (1) and/or are welded, riveted, glued or clipped to the release lever (1) in a multi-part embodiment.

### DETAILED DESCRIPTION OF THE INVENTION

The invention is based on the technical problem of creating a multi-functional lever of the type described above, characterized by its simple and functional construction with several actuating functions.

To solve this problem, this type of multi-functional lever is characterized by a basic lever for a first actuating function and one or possibly more lever elements, branching off from the basic lever, for a second and possibly further actuating functions, with the lever elements forming a sub-assembly with the basic lever or being connected to the basic lever (as more or less separate levers).—As a result of these measures of the invention, a multi-functional lever is provided, whose basic lever can be used for its original actuating function. Where, in addition, several actuating functions are required, this basic lever can contain a respective number of lever elements for the other required actuating functions, in which said lever elements can form a single part with the basic lever but, preferably, can be connected to the basic lever as required. In the latter case, the lever elements are preferably riveted to the basic lever or clipped to the basic lever. In a steel embodiment, also an adhesive connection by means of welding, is possible. There is also the option of connecting the lever elements with the basic lever on the same axis, where the basic lever is pivotably arranged on a swiveling axis for executing its actuating function. In general, the lever elements on the basic lever can also be arranged to pivot, for instance, against stops. At least in case of riveting or welding, the lever elements are, however, rigidly connected to the basic lever.

According to one embodiment of the invention that is of independent significance, a multi-functional lever for a vehicle door latch with at least a catch, a pawl for the catch and with a release lever for the actuation of the pawl, is characterized in that the release lever, as the basic lever, contains at least one driving arm in form of a branching off lever element, cooperating with its motor-driven driving wheel. In this embodiment, the release lever can thus on one hand be mechanically actuated by, for instance a Bowden cable, although there is also the option, to operate the same release lever by means of a motor. In this case a, for instance, electrical motor with a pinion gear or worm gear will be connected to a driving wheel containing a gear rim or gear rim section. The driving wheel appropriately contains a radial cam for the driving arm that rests against this radial cam and ensures that, with the driving wheel rotating, the release lever carries out a rotating motion for actuating the pawl, so as to engage or disengage the pawl. In addition, the release lever, as a basic lever, can however, as part of the invention, fulfill a further actuating function, where the release lever also contains an operating lever as a branching-off lever element. With the aid of this operating lever an internal or external release lever or also a central locking lever of the vehicle door latch can be moved as a result of the release lever being pivoted. As lever elements of the above claimed embodiment, both the operating lever and the driving arm can be designed as multiple components or as an integral part of the release lever, as basic lever. In a multiple component embodiment, the driving arm and the operating lever can, in turn, be riveted or clipped to the release lever. An embodiment made, preferably, from plastic or steel is also possible. In the first instance, a glued connection would also be possible. In the latter and in case of a single-component embodiment, the operating lever and the driving arm can also be welded to the release lever.

The figures show a multi-functional lever for the lever mechanism of a vehicle door latch. This multi-functional lever contains a basic lever 1 for a first actuating function and two lever elements 2, 3 branching off from the basic lever 1, for a second and third actuating function, in which the lever elements 2, 3 form a sub-assembly with the basic lever 1 in a single-component embodiment or can also be connected to the basic lever 1 as separate lever elements.

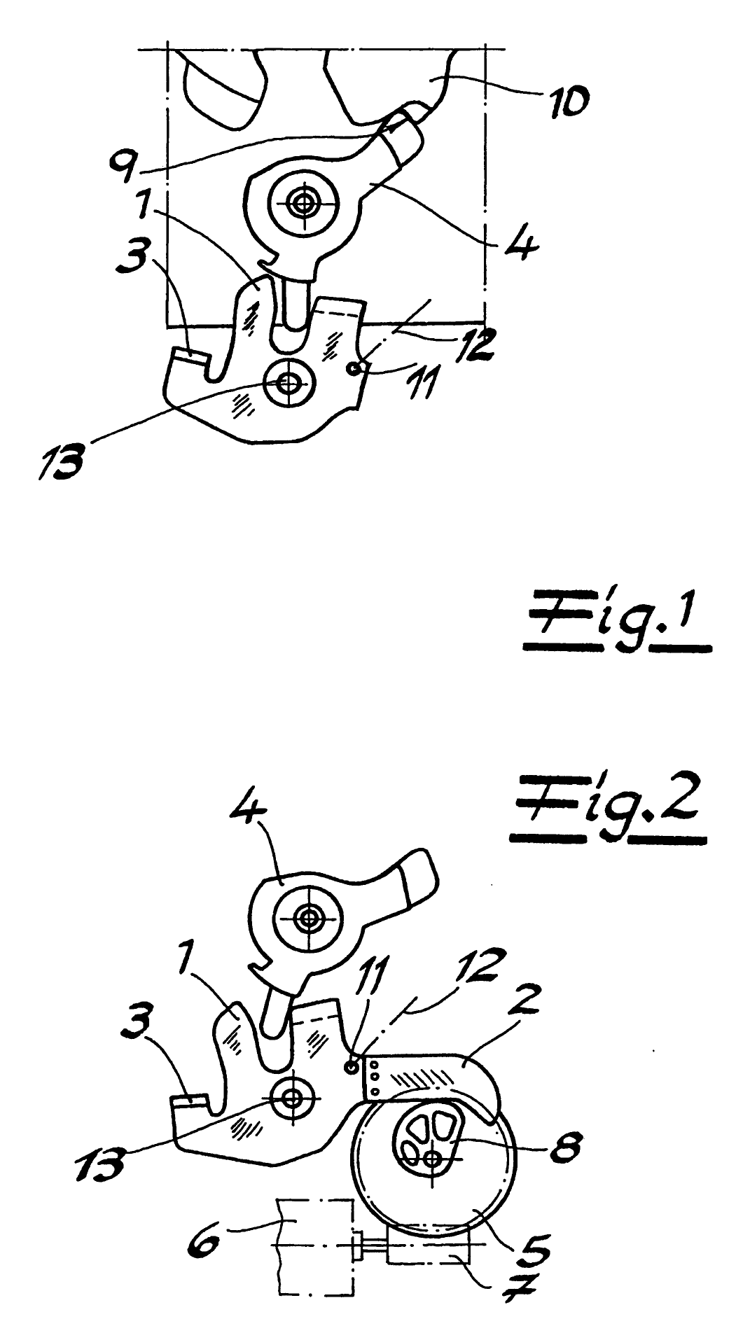

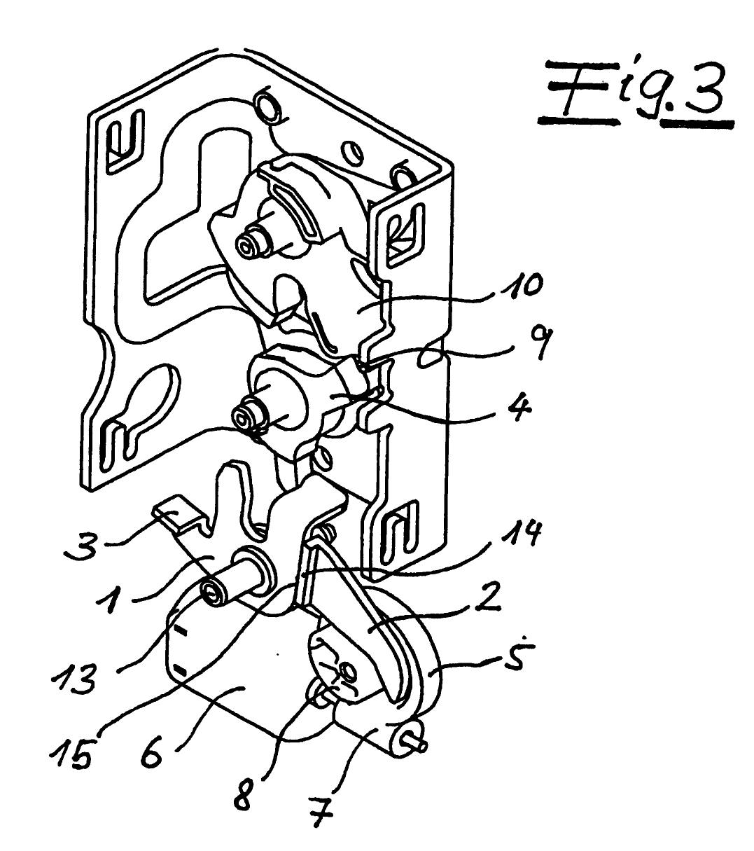

As part of the embodiment shown in FIG. 1, only the lever element 3 is rigidly connected to the basic lever 1. On the other hand, this embodiment does not contain the additional lever element, as a mechanical actuation of the shown release levers 1, 3, consisting of basic lever 1 and lever element 3 is intended. In contrast, the release lever 1, 2, 3 according to FIG. 2, is motor driven with, in this case, the lever element 2 for the connection of an electrical motor 6 acting upon a driving wheel 5 together with the worm gear 7. In fact, the lever element 2, riveted in this case to the basic lever 1, is a driving arm, cooperating with the motor-driven driving wheel 5.

As part of this process, the electrical motor 6 with its worm gear 7 acts upon the driving wheel 5, containing a gear rim section, said driving wheel also containing a radial cam 8 for the driving arm 2. When the driving wheel 5 is driven, the release lever 1, 2, 3 carries out a rotating motion and actuates the pawl 4 that either drops into the indicated primary position 9 of the catch 10 or is instead lifted out of it.

The additional lever element 3 is designed as an operating arm and forms a subassembly with the basic lever 1. In this respect, the operating lever 3 or the operating arm is, for instance, connected to an internal or external release lever or also a central locking element. The entire lever mechanism, consisting of the basic lever 1 and the lever elements 2, 3, can be made of metal, plastic or a combination the two materials.

As part of the mechanical version shown in FIG. 1 with the release lever 1, 3, consisting of the basic lever 1 and the operating lever or operating arm 3, the release lever 1, 3 is pivoted mechanically. For this purpose, the release lever 1, 3 or the basic lever 1 contains a recess or hole 11, into which a connecting element 12 engages. With the aid of connecting element 12, which can be a Bowden cable, rod, etc., the release lever 1, 3 of the mechanical version can be manually pivoted anti-clockwise around its axis 13 during the transition from FIG. 1 to FIG. 2 so that, as a result, the interacting pawl 4 is lifted out in relation to the catch 10. As already stated, lever element 2 or lever arm 2 are missing in case of a mechanical actuation of the release lever 1, 3.

According to the invention, it is now possible by using the same basic lever 1 (and the corresponding lever element 3) to upgrade the described version, by enabling electric opening of the locking mechanism 4, 10, consisting of pawl 4 and catch 10. For this purpose, the lever element 2 or the driving arm enters into the already described connection, with basic lever 1 consisting mainly of a riveted connection according to FIG. 2. In general, also other options for coupling the lever arm 2 to the basic lever 1 are possible and part of the object of the invention, such as snap-in, bolted or adhesion connections.

In any case, there is the option of designing the lever mechanism with the basic lever 1, the pawl 4 and the catch 10 in the back plate and, irrespective of which function is to be carried out by the vehicle door latch. Depending on the requirements of the customer, this basic version can be equipped with the additional lever element 3 as operating arm, in order to, for instance, be able to mechanically ensure opening of the locking mechanism 4, 2 with the aid of an external release levers or also an internal release lever.

Where, for instance, at this point, no external release lever exists, as the respective vehicle door does not contain a handle, the respective lever element 3 is no longer required. In this case only the internal release lever is regularly left to act upon the basic lever 1 through the connecting element 12 and the hole 11. Where, in this case, also electrical opening is required, the lever element 2 is connected to the basic lever 1 and the electrical motor 6, the worm gear 7 and driving wheel 5 with the radial cam 8 are positioned in the back plate.

As part of the embodiment according to FIG. 3, the driving arm 2 is designed as a separate lever element, pivotably arranged with the release lever 1, 3, consisting of basic lever 1 and lever element 3, on axis 13. The driving arm 2 contains a stop 14, corresponding with a, preferably, level profile 15 of the release lever 1, 3, so that the release lever 1, 3 and driving arm 2 form an interlocking construction. The connected driving arm 2 and release lever 1, 3 form in this way the multi-functional lever 1, 2, 3, that can be pivoted via the driving wheel 5, driven by the electric motor or the radial cam 8.

Anti-clockwise pivoting of the driving arms 2 of the multi-functional lever 1, 2, 3 during the transition from FIG. 3 to FIG. 2 will, in any case, lead to the pawl 4 being lifted out of primary position 9 in relation to the catch 10.

1-10. (canceled)

11. A multifunctional lever comprising:
a basic lever (1) for performing an actuating function; and
one or more lever element(s) (2, 3) for performing one or more actuating functions;
said basic lever (1) and said lever element(s) (2, 3) being separate parts; and
said basic lever (1) and said lever element(s) (2, 3) being connected together.

12. The multifunctional lever of claim 11, wherein said basic lever (1) is made of metal or plastic, or a combination of metal and plastic.

13. The multifunctional lever of claim 11, wherein one or more said lever element(s) (2, 3) are made of metal or plastic, or a combination of metal and plastic.

14. The multifunctional lever of claim 12, wherein one or more said lever element(s) (2, 3) are made of metal or plastic, or a combination of metal and plastic.

15. The multifunctional lever of claim 11 comprising two or more lever elements.

16. The multifunctional lever of claim 11 comprising three or more lever elements.

17. The multifunctional lever of claim 11, wherein said basic lever (1) and said one or more lever element(s) (2, 3) have the same axis of rotation.

18. The multifunctional lever of claim 11, wherein said one or more lever element(s) are rigidly connected to said basic lever (1).

19. The multifunctional lever of claim 11, wherein said one or more lever element(s) are mechanically actuated.

20. A multifunctional lever comprising:
a basic lever (1) for performing an actuating function; and
one or more additional lever(s) (2, 3) for performing one or more actuating functions;
wherein said one or more additional lever(s) (2, 3) are riveted, bolted, clipped, snapped-in, welded or glued to said main lever (1).

21. The multifunctional lever of claim 20, wherein said basic lever (1) is made of metal or plastic, or a combination of metal and plastic.

22. The multifunctional lever of claim 20, wherein one or more said lever element(s) (2, 3) are made of metal or plastic, or a combination of metal and plastic.

23. The multifunctional lever of claim 21, wherein one or more said lever element(s) (2, 3) are made of metal or plastic, or a combination of metal and plastic.

24. The multifunctional lever of claim 20 comprising two or more lever elements.

25. The multifunctional lever of claim 20 comprising three or more lever elements.

26. The multifunctional lever of claim 20, wherein said basic lever (1) and said one or more lever element(s) (2, 3) have the same axis of rotation.

27. The multifunctional lever of claim 20, wherein said one or more lever element(s) are rigidly connected to said basic lever (1).

28. The multifunctional lever of claim 20, wherein said one or more lever element(s) are mechanically actuated.

29. A vehicle door latch comprising:
a catch (10);
a pawl (4);
a basic lever (1) for performing an actuating function; and
one or more additional lever(s) (2, 3) for performing one or more actuating functions;
said basic lever (1) and said additional lever(s) (2, 3) being separate parts; and
said basic lever (1) and said additional lever(s) (2, 3) being connected together.

30. The vehicle door latch of claim 29, wherein said one or more additional lever(s) (2, 3) are riveted, bolted, clipped, snapped-in, welded or glued to said main lever (1).

31. The vehicle door latch of claim 29, wherein said basic lever (1) is made of metal or plastic, or a combination of metal and plastic and one or more said lever element(s) (2, 3) are made of metal or plastic, or a combination of metal and plastic.

32. The vehicle door latch of claim 29, wherein one said lever element (2) is attached to a driving wheel (5), said driving wheel being motor-driven.

33. The vehicle door latch of claim 32, wherein an electrical motor (6) having a worm gear (7) acts upon said driving wheel (5), said driving wheel (5) comprising further a gear rim or a gear rim section.

34. The vehicle door latch of claim 33, wherein said driving wheel (5) comprises further a radial cam (8) for interacting with said lever element (2).

35. The vehicle door latch of claim 29, wherein said one or more lever element(s) are mechanically actuated.

36. The vehicle door latch of claim 29, wherein said one or more lever element(s) are electrically actuated.
